(19) United States
(12) Patent Application Publication
(10) Pub. No.: US 2002/0070506 A1
(43) Pub. Date: Jun. 13, 2002

(54) Sealing assembly

(76) Inventor: Werner Krude, Neunkirchen-Seelscheid (DE)

Correspondence Address: Robert P. Renke, Suite 250, 28333 Telegraph Road, Southfield, MI, 48034, US

(21) Appl. No.: 09/993,873

(22) Filed: Nov. 16, 2001

(30) Foreign Application Priority Data
Nov. 17, 2000 (DE) 200 19 546.8

(51) Int. Cl. F16J 15/38

(52) U.S. Cl. 277/391

(57) ABSTRACT

The invention relates to a sealing assembly for a connection between a wheel hub (11) and an outer joint part (28) of a constant velocity rotary joint (12). The wheel hub (11) is held in a wheel bearing (16) and includes a driving ring (26) adjoining an inner bearing race (18) of the wheel bearing. The driving ring includes outer toothing (45). The constant velocity rotary joint (12) forms a cylindrical projection (29) which points towards the wheel hub (11) and includes an inner toothing (46), such that the outer toothing (45) registers with the inner toothing (46). The driving ring (26) and the cylindrical projection (29) are each provided with annular grooves (41, 42) into which there is inserted a securing ring (36). The sealing assembly also includes a resilient sleeve (13) which, at one end, is positioned on an outer face (47) on the cylindrical projection (29) to cover the securing ring (36) on an outside and which, at its other end, sealingly co-operates with an annular part secured on the wheel hub (11).

### TECHNICAL FIELD

The present invention relates to a sealing assembly for a connection between a wheel hub and an outer joint part of a constant velocity joint.

### BACKGROUND OF THE INVENTION

A sealing assembly is typically provided on a connection between a wheel hub and an outer joint part of a constant velocity joint. The wheel hub is held in a wheel bearing on which there is positioned a driving ring adjoining an inner bearing race of the wheel bearing and includes an outer toothing. The outer joint part of the constant velocity rotary joint forms a cylindrical projection which points towards the wheel hub and includes an inner toothing. The outer toothing and the inner toothing are inserted into one another, and the driving ring and the cylindrical projection are each provided with annular grooves into which there is inserted a securing ring.

In order to avoid any mating corrosion between the engaging outer toothing and inner toothing, it has so far been common practice to use a permanent elastic paste to avoid direct metallic contact in connection with micro-movements between the surfaces of the engaging toothings. The reliability and service life of such pastes used to prevent mating corrosion is not foreseeable.

It is therefore desirable to provide an improved sealing assembly which ensures an improved corrosion protection for the engaging toothings.

### SUMMARY OF THE INVENTION

An improved sealing assembly is provided through the provision of a resilient sleeve which, at one end, is positioned on an outer face on the cylindrical projection, to cover the securing ring on the outside, and which, at the other end, sealingly co-operates with an annular part secured on the wheel hub.

In one embodiment, the resilient sleeve is formed by a piece of plastic hose which is slid on to an annular face on the cylindrical projection of the outer joint part prior to the joint and hub being assembled relative to one another. The securing ring is inserted into an inner groove in the cylindrical projection. While being slid on to the driving ring, the securing ring widens at a stop cone at the end face in order to snap into an outer groove in the driving ring after the two toothings have been inserted into one another. To enable dismantling of the connection, the sealing assembly has to be destroyed and the securing ring has to be widened to such an extent that it moves out of the outer groove in the driving ring. The inner groove in the cylindrical projection is correspondingly deep to permit such widening. For widening purposes, the securing ring is preferably provided with radially outwardly bent ends which can be handled by a suitable tool.

According to alternative embodiments, the annular part secured in the wheel hub is a sealing ring of the wheel bearing, or the annular part secured on the wheel hub is a plate-metal ring slid on to the driving ring, such as an ABS trigger ring. According to other embodiments, the resilient sleeve is slid on to a cylindrical projection at the sealing of the wheel bearing, or the resilient sleeve is flush with and abuts the end face of the sealing of the wheel bearing. Finally, according to a further embodiment, the resilient sleeve engages an annular groove in the sealing of the wheel bearing.

Other advantages of the invention will become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 shows a longitudinal section of a sealing assembly according to an embodiment of the present invention.

FIG. 2 shows a sealing assembly according to an embodiment of the present invention in axial cross-section.

FIG. 3 shows an enlarged detail of the sealing assembly according to FIG. 1.

FIG. 4 shows an enlarged detail of a sealing assembly according to an alternative embodiment.

FIG. 5 shows an enlarged detail of a sealing assembly according to another embodiment.

FIG. 6 shows an enlarged detail of a sealing assembly according to a further embodiment.

FIG. 7 shows an enlarged detail of a sealing assembly according to yet another embodiment.

### DETAILED DESCRIPTION OF THE INVENTION

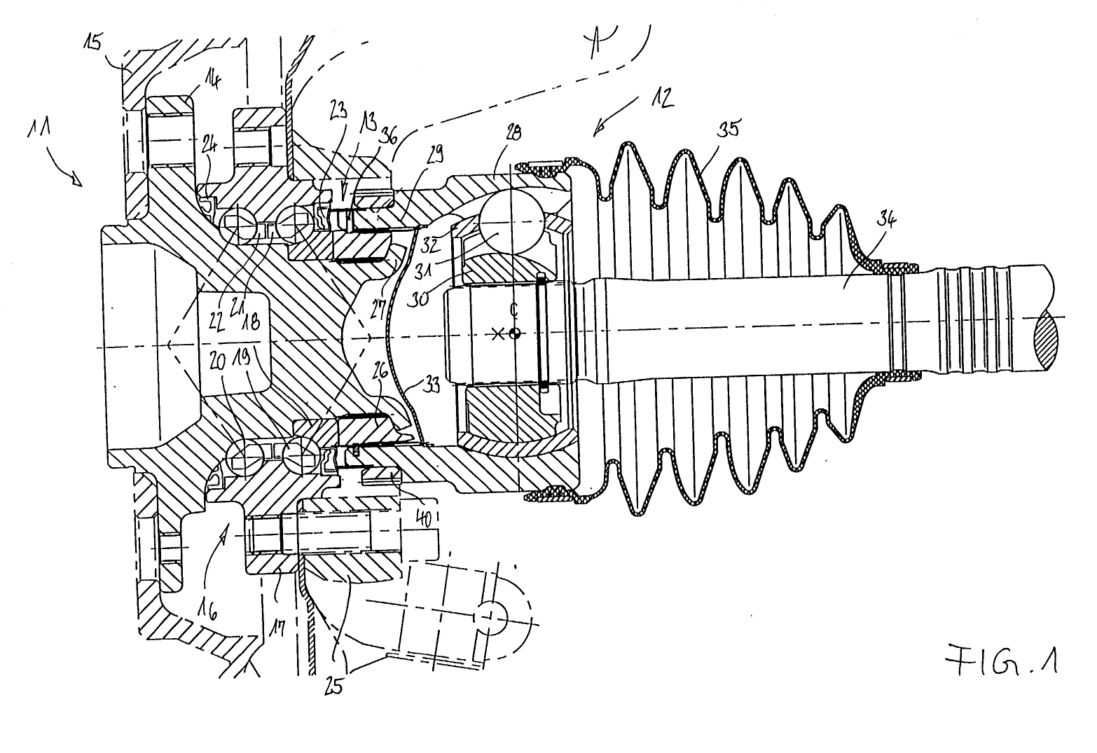

FIG. 1 shows an assembly including a wheel hub 11 and a constant velocity rotary joint 12. The assembly is provided with a sealing assembly according to the present invention in the form of a cylindrical sleeve 13.

The wheel hub 11 includes a flange 14 to which there is attached a wheel disc 15. The wheel hub is held in a double-row wheel bearing 16 which is shown as including an outer bearing race 17, an inner bearing race 18 slid on to the wheel hub 11, and two rows of balls 19, 20 with their associated cage elements 21, 22. The wheel bearing 16 is outwardly sealed by sealing rings 23, 24. The wheel bearing 16 is bolted to a wheel carrier 25. The inner bearing race 18 is directly adjoined by a driving ring 26 which is slid on to the wheel hub 11. The driving ring 26 is held by a beading 27 on the wheel hub so as to be tensioned against the inner bearing race 18.

The constant velocity rotary joint 12 includes an outer joint part 28 with a cylindrical projection 29, an inner joint part 30, torque transmitting balls 31 and a ball cage 32. A sealing plate-metal cover 33 is inserted into the cylindrical projection, and a shaft 34 is inserted into the inner joint part 30. The aperture between the outer joint part 28 and the shaft 34 is sealed by a convoluted boot 35. A securing ring 36 serves to axially secure the driving ring 26 relative to the cylindrical projection 29.

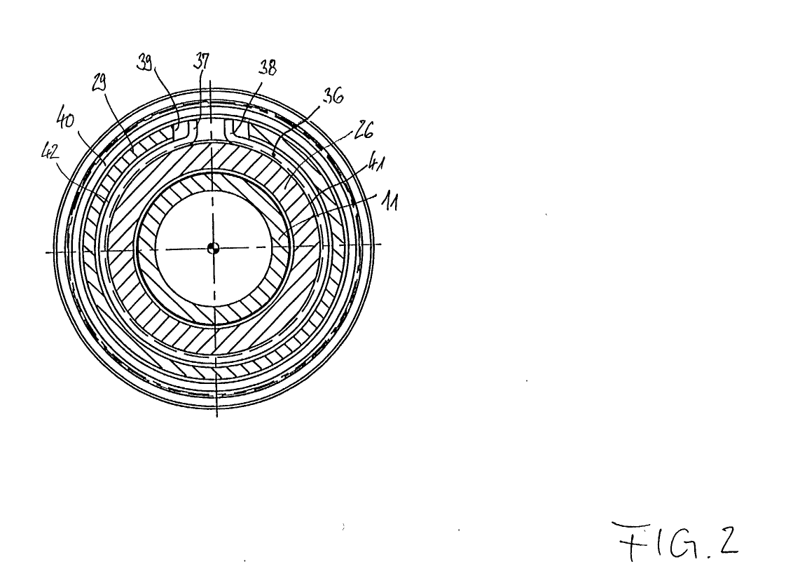

FIG. 2 shows that the securing ring 36 includes radially outwardly opening bent ends 37, 38 which pass through a radial gap 39 in the cylindrical projection 29 to permit the securing ring to be widened radially from the outside. On the cylindrical projection 29 there is provided a trigger ring 40, marked on the outside, for an ABS system. The securing ring engages an inner annular groove 41 in the driving ring and an outer annular groove 42 in the cylindrical projection 29.

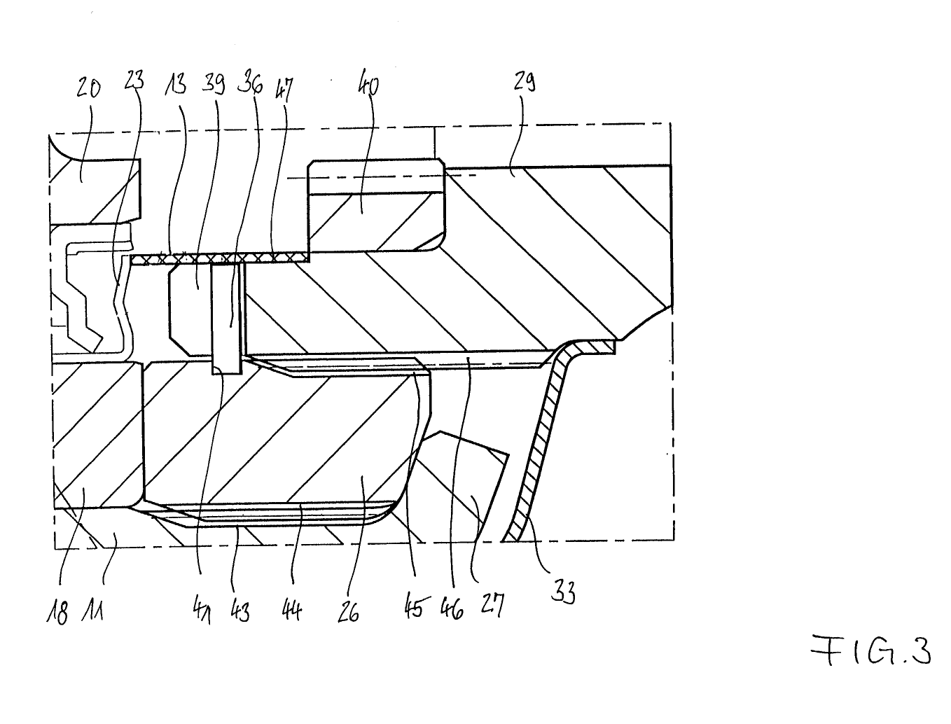

In FIG. 3, any details identical to those shown in FIG. 1 have been given the same reference numbers. To that extent, reference is made to the respective description. As can be seen in FIG. 3, an outer toothing 43 at the wheel hub 11 and an inner toothing 44 at the driving ring 26 engage one another in a rotationally fast way. Furthermore, an outer toothing 45 is provided at the driving ring and an inner toothing 46 at the cylindrical projection; they also engage one another in a rotationally fast way. It can also be seen that the sealing assembly is provided in the form of a piece of resilient hose 13 which is positioned on an externally cylindrical face 47 of the projection 29. The resilient hose 13 covers the securing ring 36 and the radial slot 39 and, at its other end, is flush with and abuts the sealing ring 23 of the bearing assembly.

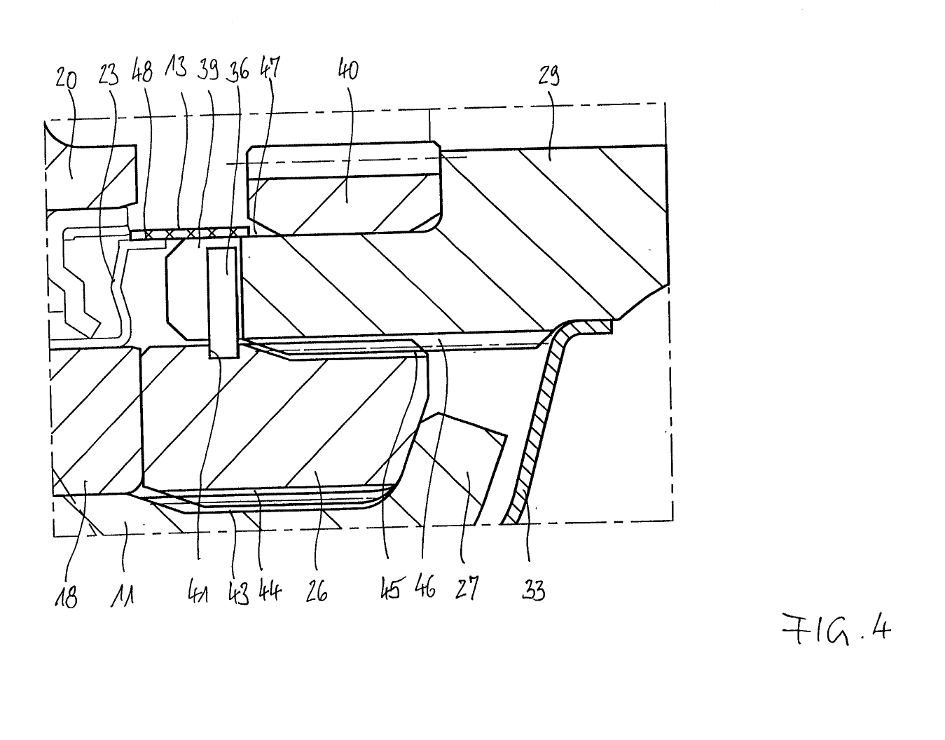

In FIG. 4, any details identical to those shown in FIG. 3 have been given the same reference numbers as those in FIG. 3. To that extent, reference is made to the description above. However, FIG. 4 deviates from FIG. 3 in that part of the sealing ring 23 is provided with a cylindrical projection 48 on to which the second end of the resilient sleeve 13 has been slid.

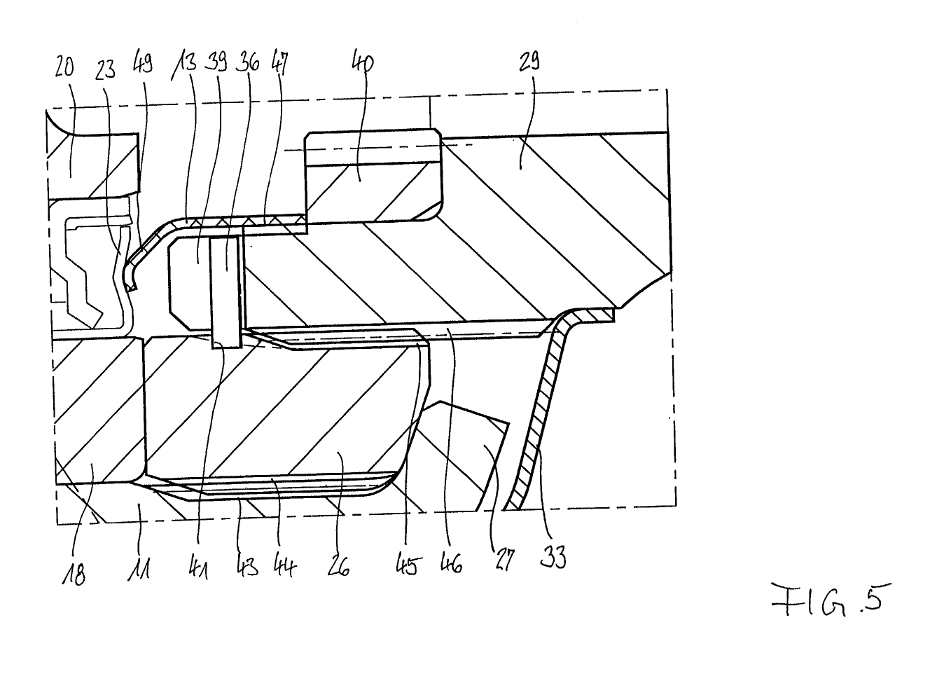

Any details in FIG. 5 which correspond to those in FIGS. 3 and 4 have been given the same reference numbers. To that extent, reference is made to the description above. However, FIG. 5 deviates from FIGS. 3 and 4 in that the resilient sleeve 13, at its free end, comprises a conical tapering 49 which form-fittingly engages a groove in the seal 23 of the wheel bearing.

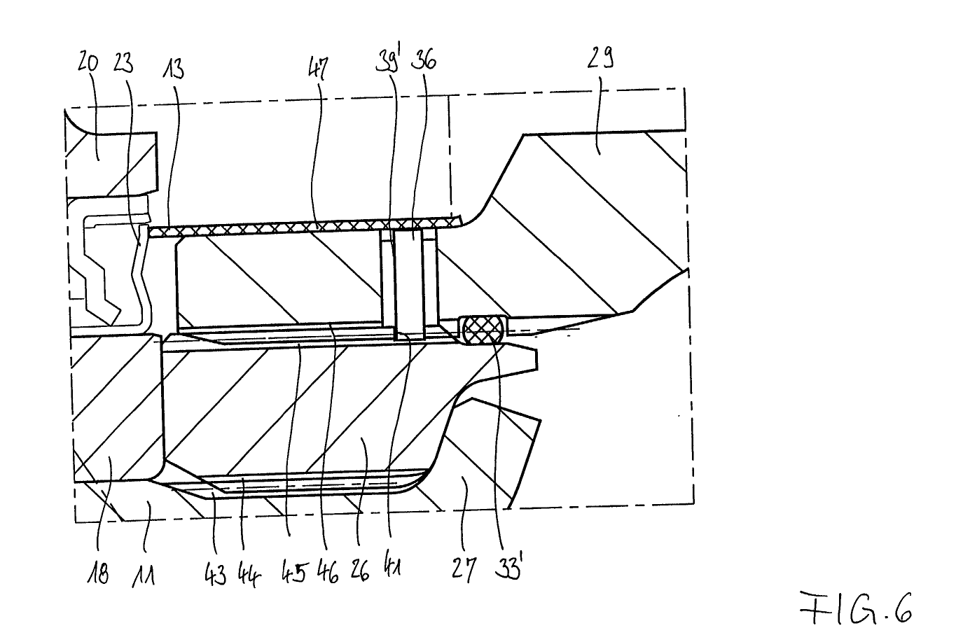

FIG. 6 substantially corresponds to the embodiment according to FIG. 3. Any details identical to those shown in FIGS. 3 to 5 have been given the same reference numbers. To that extent, reference is made to the description above. FIG. 6 deviates from FIG. 3 however, in that instead of the slot 39 at the end face, there is provided a radial bore 39′ in the cylindrical projection 29 to accommodate the free ends of the securing ring 36. The resilient sleeve 13, in the same way, is flush with and abuts the sealing ring 23 for the radial bearing. A trigger ring for an ABS system is not provided in this case. Instead of the cover 33, there is used an O-ring 33′ as a seal.

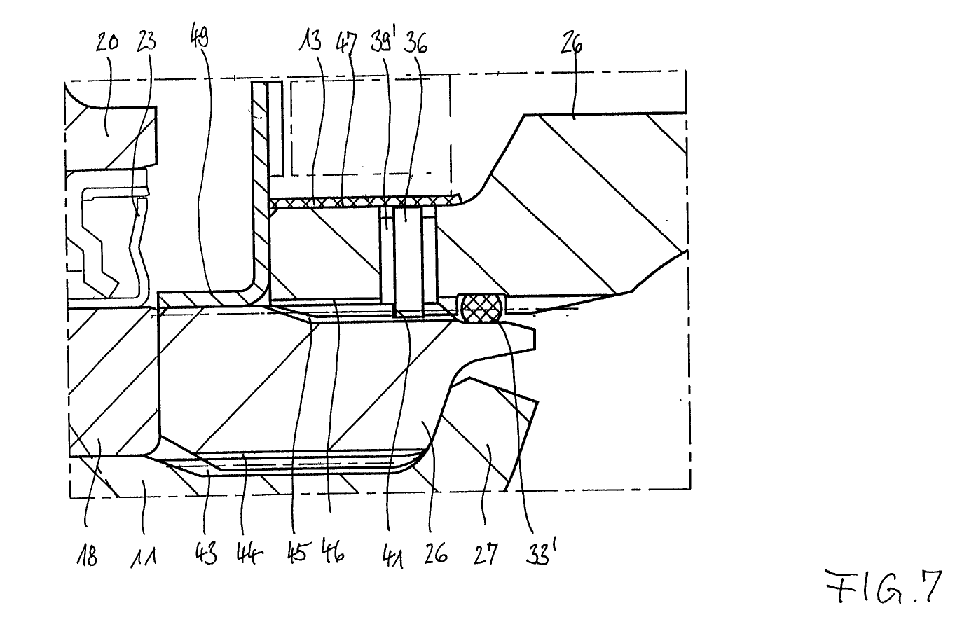

FIG. 7 substantially corresponds to the embodiment according to FIG. 6. Any details identical to those shown in FIGS. 3 to 6 have been given the same reference numbers. To that extent, reference is made to the description above. FIG. 7 deviates from FIG. 6 in that, at the bearing end of the driving ring 26, there is slid on a plate metal ring 49 which is L-shaped in a cross-sectional view, with the resilient sleeve 13 being flush with and directly abutting the plate-metal ring 49. The plate-metal ring marked at its end face can be a trigger ring for an ABS system.

From the foregoing it can be seen that there has been brought to the art a new and improved sealing assembly for a wheel hub and constant velocity joint. While the invention has been described in connection with one or more embodiments, it should be understood that the invention is not limited to those embodiments. On the contrary, the invention covers all alternatives, modifications, and equivalents as may be included in the spirit and scope of the appended claims.

What is claimed is:

1. A sealing assembly for a connection between a wheel hub (11) and an outer joint part (28) of a constant velocity rotary joint (12), wherein the wheel hub (11) includes a driving ring (26) adjoining an inner bearing race (18) of a wheel bearing (16), the driving ring (26) comprising an outer toothing (45), and wherein the constant velocity rotary joint (12) forms a cylindrical projection (29) which points towards the wheel hub (11) and comprises an inner toothing (46) such that the outer toothing (45) registers with the inner toothing (46), and wherein the driving ring (26) and the cylindrical projection (29) are each provided with annular grooves (41, 42) into which there is inserted a securing ring (36), the sealing assembly comprising:
a resilient sleeve (13) which, at one end, is positioned on an outer face (47) on the cylindrical projection (29) to cover the securing ring (36) on an outside and which, at its other end, sealingly co-operates with an annular part secured on the wheel hub (11).

2. A sealing assembly according to claim 1 wherein the annular part secured on the wheel hub (11) is a sealing ring (23) of the wheel bearing.

3. A sealing assembly according to claim 1 wherein the annular part secured on the wheel hub is a plate-metal ring (49) slid on to the driving ring (26).

4. A sealing assembly according to claim 1 wherein the annular part secured on the wheel hub is an ABS trigger ring slid onto the driving ring (26).

5. A sealing assembly according to claim 2 wherein the resilient sleeve (13) is slid on to a cylindrical projection (48) at the sealing ring (23) of the wheel bearing.

6. A sealing assembly according to claim 2 wherein the resilient sleeve (13) is flush with and abuts the end face of the sealing ring (23) of the wheel bearing.

7. A sealing assembly according to claim 2 wherein the resilient sleeve (13) engages an annular groove in the sealing ring (23) of the wheel bearing.

8. An assembly comprising:
a wheel hub (11) having a driving ring (26) adjoining an inner bearing race (18) of a wheel bearing (16), said driving ring (26) including outer toothing (45);
a constant velocity joint (12) comprising an outer joint part (28) including a cylindrical projection (29) pointing towards the wheel hub (11), said cylindrical projection (29) including an outer face (47) and inner toothing (46) adapted to register with said outer toothing (45);
a securing ring (36) adapted to seat in respective annular grooves (41, 42) of said driving ring (26) and said cylindrical projection (29); and
a resilient sleeve (13) carried on said outer face (47) and covering said securing ring (36) and sealingly cooperating with an annular part secured on said wheel hub (11).

9. An assembly according to claim 8 wherein the annular part secured on the wheel hub (11) is a sealing ring (23) of the wheel bearing.

10. An assembly according to claim 8 wherein the annular part secured on the wheel hub is a plate-metal ring (49) slid on to the driving ring (26).

11. An assembly according to claim 8 wherein the annular part secured on the wheel hub is an ABS trigger ring slid onto the driving ring (26).

12. An assembly according to claim 8 wherein the resilient sleeve (13) is slid on to a cylindrical projection (48) at the sealing ring (23) of the wheel bearing.

13. An assembly according to claim 9 wherein the resilient sleeve (13) is flush with and abuts the end face of the sealing ring (23) of the wheel bearing.

14. An assembly according to claim 9 wherein the resilient sleeve (13) engages an annular groove in the sealing ring (23) of the wheel bearing.
